(19) United States
(12) Patent Application Publication
(10) Pub. No.: US 2003/0176610 A1
(43) Pub. Date: Sep. 18, 2003

(54) Poly(methylene/polyethylene terephthalate) copolymers

(76) Inventors: A. George Pinkus, Robinson, TX (US); Rajan Hariharan, Duluth, GA (US)

Correspondence Address: JACKSON WALKER L.L.P., Suite 2100, 112 E. Pecan Street, San Antonio, TX, 78205, US

(21) Appl. No.: 10/365,079

(22) Filed: Feb. 12, 2003

Related U.S. Application Data
(60) Provisional application No. 60/356,402, filed on Feb. 12, 2002.

(51) Int. Cl. C08F 20/10

(52) U.S. Cl. 526/318

(57) ABSTRACT

The present invention comprises a method of making a polyethylene/methylane terephthalate copolymer with more desirable properties by the incorporation of a minor percentage of poly(methylene) components. Applicants have found, as demonstrated herein, that a small amount of this poly(methylene terephthalate) incorporated into the poly/ethylene terephthalate) serves to drastically depress the melting point. Such depression of melting points will make the production of fibers from melting polymers less expensive. Applicants have also found that the mixture with the depressed melting point has apparently less adherence to the surfaces of the equipment used to handle such molten polymers.

This application is based on and claims priority from provisional patent application, Serial No. 60/356,402, filed Feb. 13, 2002 and incorporated by reference herein.

### FIELD OF THE INVENTION

The present invention relates to poly(ethylene/methylene terephthalate) copolymers.

Poly(ethylene terephthalate) (PET) is a commercially important polyester having many applications. PET is known under trade names such as Dacron® (DuPont), Mylar® film, Kodel® (Eastman Kodak) and Terylene® (Terene). Of several methods of preparation, the most common is the catalyzed ester interchange between dimethyl terephthalate and ethylene glycol involving removal of methanol to drive the reaction to completion. Poly(ethylene terephthalate) was reportedly prepared by reaction with cesium terephthalate; however no details are given and the other reactant was not mentioned (G. C. East and M. Morshed, Polymer, 1982, 23:168). A commercial sample of poly(ethylene terephthalate) had Mₙ=3,600. Poly(ethylene isophthalate) has been previously synthesized by Nishikubo, T. and K. Ozaki (Polym. J. 1990, 22:1043).

### SUMMARY OF THE INVENTION

The present invention concerns including a lower amount of methylene monomer in poly(ethylene/methylene terephthalate) copolymer, giving rise to a copolymer having a much depressed melting point. The peak of this melting point depression occurs between about 1 mol % and about 14 mol % polymethylene component (86-99 mol % polyethylene). The maximal melting point depression occurs from about 6% to 8% poly(methylene terephthalate/polyethylene terephthalate). Under certain conditions this ultimate reduction of melting point illustrate occurred at about 7.4 mol % poly(methylene terephthalate). The copolymer with a lowered melting point was also found to have less adherence to the surfaces of molten polymer-handling equipment.

### BRIEF DESCRIPTION OF THE DRAWINGS

FIG. 1. illustrates trialkylamine-carboxylate interaction.

FIG. 2. shows halogen (X) displacement by the carboxylate oxygen of a ternary amine carboxylate salt.

FIG. 3. shows melting points as a function of methylene/ethylene composition of poly(methylene ethylene terephthalates) prepared by using tetrabutylammonium terephthalate promoter.

FIG. 4. schematically shows formation of PMT/PET copolymer.

FIG. 5. schematically shows structure of a PMT/PET polymer.

FIG. 6. shows melting points as a function of methylene/ethylene composition of poly(methylene ethylene terephthalates) prepared from methylene halides and 1,2-dibromoethylene and terephthalic acid using triethylamine promotor.

### DESCRIPTION OF THE PREFERRED EMBODIMENTS

The present invention concerns including an amount of poly(methylene terephthalate) with poly(ethylene terephthalate), giving rise to a copolymer having a much depressed melting point. The peak of this melting point depression occurs between about 1 mol % and about 14 mol % polymethylene component. The maximal melting point depression more occurred from about 6 mol % to 8 mol % poly(methylene terephathalate/polyethlene terephthalate). Under certain conditions this optimal reduction of copolymer melting point occurred at about 7.4 mol % poly(methylene terephthalate). The following Examples establish two different approaches to this point as seen in various Tables or Figures herein.

For CH₂XY and XCH₂CH₂Y, X and Y, in addition to halogens, can be any replaceable atoms or groups such as, for example, OR where R can be alkyl such as methyl, ethyl, propyl, benzyl, or the like. By the term “mol %” is meant that total moles of ethylene and methylene as monomers of a polymer or as halide precursors are 100 mol %. 25 mol % methylane of course means 1/4monomers or precursors are methylene, the rest being ethylene.

### EXAMPLE I

### Preparation of Poly(methylene terephthalate)/Poly(ethylene terephthalate) Composites Using Tetrabutylammonium Terephthalate

In previous work (1), poly(methylene/ethylene terephthalate) (PMT/PET) samples were prepared by reactions of terephthalic acid with mixtures of dihalomethanes and dihaloethanes as moderated by triethylamine (or other tertiary amines) (2). The relative feed ratios of the halide reactants were at intervals of about 25% and initially appeared to show a minimum melting point range at about a 50% ratio of these two reactants as normally expected. In an extension of this research (3) the present inventors found that at lower relative amounts of the dihalomethanes, the copolymer melting points decreased to a second minimum at about 10% of the dihalomethane. An important aspect of these copolymers was the finding that at relatively low percentages of methylene component significantly lower melting points were obtained. A significant advantage of these lowered melting points is the savings in heat energy that would occur during the processing of various items made by melt-casting of copolymers prepared by this common technique since the melting temperature of PET alone is relatively high.

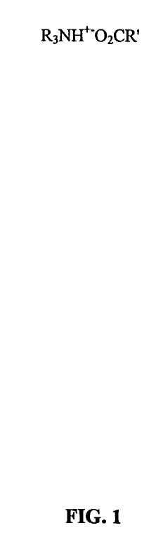

In some previous studies (4), it was found that in trialkylammonium carboxylates, the trialkylammonium group is strongly hydrogen-bonded to the carboxylate oxygens (see FIG. 1).

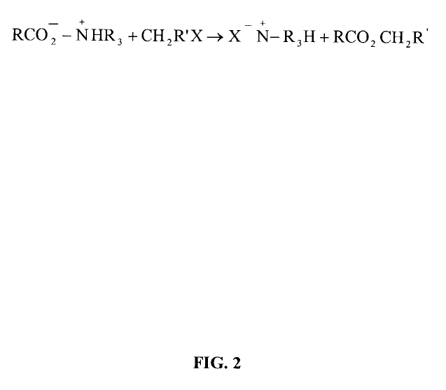

Because of this strong hydrogen-bonded attraction of the trialkylammonium group to the carboxylate oxygens, it was thought that the trialkylammonium group would present strong steric blocking (resembling a tertiary grouping) to nucleophilic attack by the carboxylate oxygens to displace an atom such as a halogen from a carbon (FIG. 2).

It was thought that if the strong hydrogen-bonded interaction could be eliminated, the reaction might be facilitated. A possible way to accomplish this would be to substitute the hydrogen in triethylammonium by another ethyl group. Although this would make the group larger it would eliminate the hydrogen-bonded interaction anchoring the triethylammonium group to the reacting carboxylate group. The tetraethylammonium group, although larger would be interactively shared by the four surrounding carboxylate groups.

Experimental Chemicals

Tetrabutylammonium hydroxide was a 1 molar solution in methanol purchased from Acros. Chlorobenzene was from Aldrich Chemical. All other chemicals were obtained as previously described (1).

Synthesis of tetrabutylammonium terephthalate

Terephthalic acid (0.831 g, 5.00×10⁻³ mol) was added to a stirred solution of tetrabutylammonium hydroxide in methanol (10 mL). The mixture was stirred for 3 hr. The mixture was evaporated using moderate heating in a vacuum oven.

Synthesis of poly(methylene terephthalate)

Ditetrabutylammonium terephthalate (1.22 g, 2.99×10⁻³ mol) was added to chlorobenzene (6 mL) and dibromomethane (0.24 mL, 0.594 g, 3.0342×10⁻³ mol) and the solution was heated to 70° C. for 3.5 hr and rotoevaporated. The white solid product was purified by stirring twice with 15 mL portions of methanol and filtering. The precipitate collected was dissolved in chloroform, reprecipitated by dropwise addition of methanol, the precipitate by filtration and dried in vacuo. Yield =0.232 g. (69% based on di-t-butylammonium terephthalate). The m.p. was 253-2557° C.

Synthesis of poly(methylene ethylene terephthalate) copolymers

As an example of the procedure used, the preparation of 93% PET/6% PMT is given. (The actual amounts of reactants as weighed were 92.6% PET/7.4% PMT.) The other copolymers were prepared using the same procedure with differing ratios of dihalomethanes and dihaloethanes.

Tetrabutylammonium terephthalate (3.43 g, 0.529×10⁻³ mol) was stirred with chlorobenzene (17 mL) and dibromoethane (9.78 mL) and dibromomethane (0.03 mL) were added. The mixture was heated at 70° C. for 3 hr. The solution was rotary evaporated to remove solvent and the solid obtained was stirred with methanol (15 mL) and the mixture was filtered. The precipitate was stirred with methanol (15 mL) again, the mixture was filtered, and the precipitate dried, 0.403 g., mp 164-166° C.

### Results

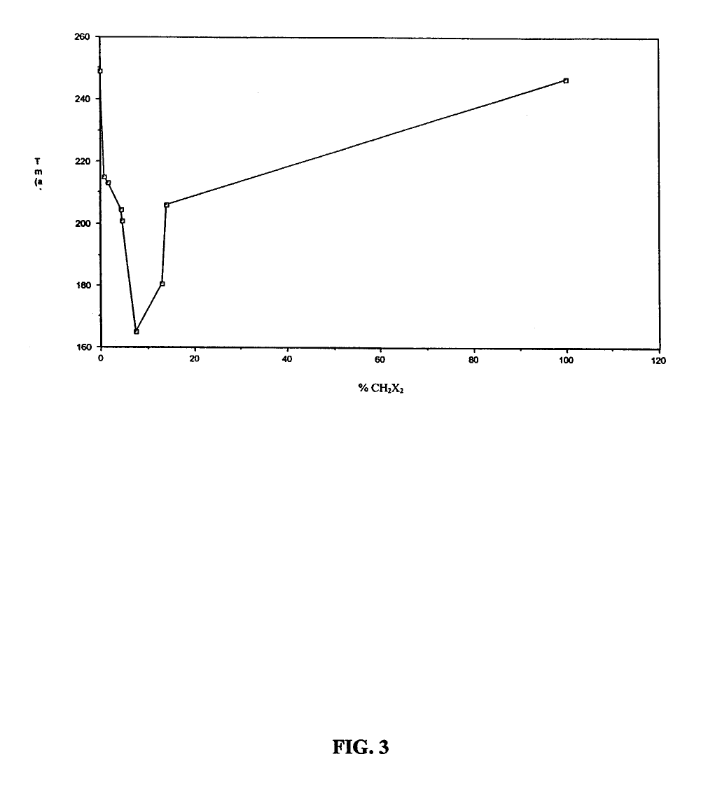

Based on the higher melting points of poly(eth ylene Terephthalate) and poly(methylene terephthalate) as compared to the poly(methylene/polyethylene terephthalate) products obtained, the postulated interaction was effective. This is evident in Table 1 as shown. In addition, the same type of minimum melting point at a relatively low content of the methylene group in the product is evident, as shown in Table 1 and FIG. 3.

TABLE 1
Synthesis and melting points of poly(methylene 1,2-ethylene
terephthalate) copolymers prepared by reactions of
ditetrabutylammonium terephthalate with
dihalomethane/1,2-dihaloethane mixtures.

| mol % | mol % | | |
|---|---|---|---|
| CH₂Br₂ | BrCH₂CH₂Br | Mp (° C.) | Yield (g) |
| 0 | 100 | 248-250 | 2.7 |
| 0.9 | 99.1 | 212-214 | 0.44 |
| 1.7 | 98.4 | 214-216 | 0.82 |
| 4.5 | 95.5 | 204-205 | 0.55 |
| 4.7 | 95.3 | 200-202 | 0.078 |
| 7.4 | 92.6 | 164-166 | 0.40 |
| 13 | 87. | 180-181 | 0.77 |
| 14 | 86 | 205-207 | 0.59 |
| 100 | 0 | 253-255 | 0.23 |

### EXAMPLE II

### PREPARATION OF POLY(METHYLENE TEREPHTHALATE)/POLY(ETHYLENE TEREPHTHALATE) COPOLYMERS USING TRIETHYLAMINE/TEREPHTHALATE

Poly(ethylene terephthalate) (PET) is probably the world's most widely used synthetic fiber (6). Its lower homolog, poly(methylene terephthalate) (PMT) has only fairly recently been prepared (7,8). In some exploratory work (1), the preparation of copolymers of PET and PMT was reported. The proportions of PET and PMT were at 25% intervals where the minimum melting point appeared to be about 50%. Since the copolymer with the lowest proportion of PMT still melted relatively low, it was of interest to find the melting temperatures of copolymers containing even lower amounts of PMT since a low melting temperature would be advantageous for processing as long as the copolymer still possessed other advantageous properties.

### EXPERIMENTAL

Chemicals, equipment, and procedures were the same as those listed (1).

### PREPARATION OF PET/PMT COPOLYMERS

As an example of the procedures used, the preparation of 91.6% PET/8.4% PMT is given. The other copolymers were prepared using the same procedure with differing ratios of dihalomethane and dihaloethanes.

Terephthalic acid (1.66 g, 0.010 mol) was added to 10 mL of diethylformamide solvent. The apparatus was flushed with nitrogen. Triethylamine (2.8 mL, 0.020 mol) was added to convert the acid into the triethylammonium salt. Dibromomethane (0.0887 g, 0.00051 mol, 0.084 mol. frac.) and 1,2-dibromoethane (0.82 mL, 1.79 g, 0.0095 mol, 0.916 mol. frac.) were added. The mixture was heated with stirring for 1.5 hr. After cooling, 10 mL of methanol was added with stirring. The precipitate was collected by filtration and dried overnight to obtain 1.425 g., mp 222-226° C.

### RESULTS

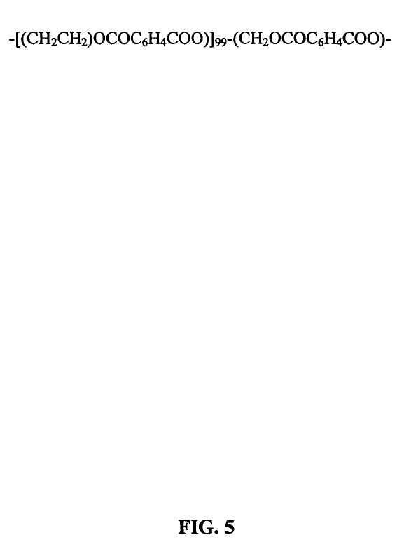

Table 2 shows the yields and corresponding melting points of the polymeric products obtained. H¹ NMR spectra showed the polymeric composition to be very close to the feed ratios. This is more clearly evident in the Figure showing the melting point as a function of composition relating to % of PMT. Thus for the polymer containing 1% PMT the structure would be contained as shown in FIG. 5.

A most interesting aspect of the results is the reduction of the melting point with a melting point minimum at about 10% content of PMT and gradually increasing to about 221° C. at about 1%. This is significantely below the melting point of PET. Since the processing of polymers takes place via melting and injection into molds, it is obvious that any reduction in melting temperature can result in a major savings in energy. This is especially significant in the case of PET since its melting point is comparatively high as compared with other polymers that are also processed by injection molding.

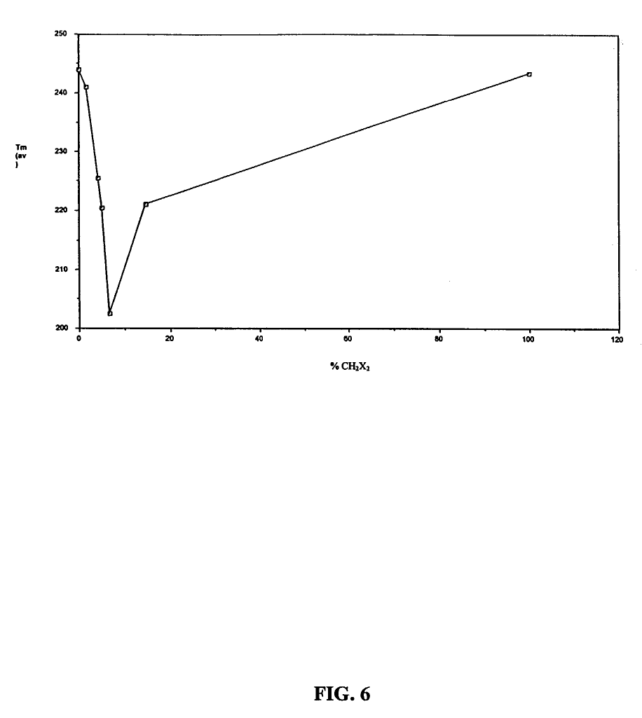

Evidence for this formulation of the structure is in experiments which showed that when ng points of mixtures in various proportions of powdered samples of PMT and PET were two melting points were obtained in all cases in which mixtures of the two were prepared by mixing the powders or by melting PMT and PET samples together and then taking the melting points. This contrasts with the M.P. results of coplymers. See FIG. 6 and Table 2.

TABLE 2
Melting points as a function of methylene/ethylene composition of
poly(methylene/ethylene terephthalates) prepared from methylene
halides and 1,2-dibromoethylene (100% minuse % CH₂X₂)
with terephthalic acid using triethylamine promotor

| | | | | |
|---|---|---|---|---|
| % CH₂X₂ | Tₘ (° C.) | Tₘ(C av) | X | Wt. Prod. (g) |

| | | | | |
|---|---|---|---|---|
| 0 | 242-246 | 244 | Cl | 0.23 (62%) |
| 1.6 | 240-242 | 241 | Br | 1.1 |
| 4.3 | 224-227 | 225.5 | Cl | 1.5 |
| 5.1 | 219-222 | 220.5 | Cl | 3.1 |
| 6.7 | 201-204 | 202.5 | Br | 2.1 |
| 14.6 | 219-223 | 221 | Br | 1.6 |
| 100 | 242-245 | 243.5 | Br | 1.17 (66%) |

The published references among the following and other cited elsewhere in this application are incorporated by reference herein.

### REFERENCES

1. A. G. Pinkus, R. Hariharan, L. P. Thrasher, A. P. Kesse, J. Macromol. Sci. Pure Appl. Chem.,A37, 1037-1051 (2000)

2. A. G. Pinkus, R. Hariharan, E. B. Watkins, unpublished research.

3. A. G. Pinkus, R. Hariharan, S. M. King, unpublished research.

4. A. G. Pinkus, R. Subramanyam, unpublished research.

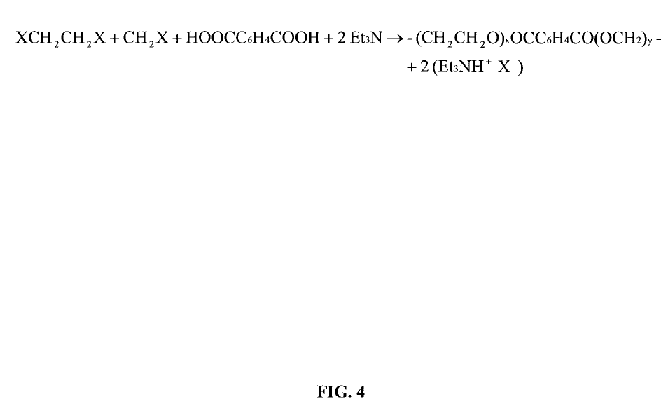

5. Based on previous studies (5), the most convenient method of preparation appeared to be triethylamine promoted polymerization of terephthalic acid with dihalomethane (for PMT sections) and with 1,2-dihaloethane (for PET) sections (see equation in FIG. 4).

6. R. B. Seymour; C. E. Carraher, Jr., Polymer Chemistry. An Introduction, Dekker, New York, 1981, p 215.

7. A. G. Pinkus; R. Hariharan, U.S. Pat. No. 5,451,643. Sep. 19, 1995.

8. A. L Cimecioglu, G. C. East; M. Morshed, J. Polym. Sci.,: Polym. Chem. 26, 2129 (1988).

We claim:

1. A poly(ethylene/methylene terephthalate) copolymer prepared by polymerizing a terephthalate with a mixture of CH₂XY and XCH₂CH₂Y where X and Y are leaving groups and the mixture is about 1 mol % to about 14 mol % CH₂XY and about 86 mol % to about 99 mol % XCH₂CH₂Y.

2. A poly(ethylene/methylene terephthalate) copolymer being about 1 mol % to about 14 mol % methylene and about 86 mol % to about 99 mol % ethylene.

3. A method of preparing a poly(ethylene/methylene terephthalate) copolymer having a minimal melting point, the method comprising polymerizing terephthalate with a mixture of CH₂XY and XCH₂CH₂Y where the mixture is about 1 mol % to about 14 mol % CH₂XY and about 86 mol % to about 99 mol % XCH₂CH₂Y where X and Y are leaving groups.

4. The copolymer of claim 1 where X and Y are halogen or O alkyl.

5. The copolymer of claim 1 where X and Y are Br or Cl.

6. The copolymer of claim 1 where the mixture is from about 6 mol % to about 8 mol % CH₂XY.

7. The copolymer of claim 1 where the mixture is about 7.4 mol % CH₂XY.

8. The method of claim 3 defined further and involving at least one of a trialkylamine promoter and a tetralkylanine promoter.

9. A fiber comprising the polymer of claim 1.
